(19) United States
(12) Patent Application Publication
(10) Pub. No.: US 2013/0146697 A1
(43) Pub. Date: Jun. 13, 2013

(54) APPARATUS FOR MOUNTING SEAT BELT RETRACTOR FOR VEHICLE

(71) Applicants: Dong Wook Kim, Seoul (KR); Chang Mo Kang, Suwon-si (KR)

(72) Inventors: Dong Wook Kim, Seoul (KR); Chang Mo Kang, Suwon-si (KR)

(73) Assignee: Kia Motors Corp., Seoul (KR)

(21) Appl. No.: 13/605,558

(22) Filed: Sep. 6, 2012

(30) Foreign Application Priority Data
Dec. 12, 2011 (KR) 10-2011-0133130

(51) Int. Cl. B60R 22/34

(52) U.S. Cl. 242/379

(57) ABSTRACT

An apparatus for mounting a seat belt retractor for a vehicle is capable of promoting the ease with which a seat belt retractor is mounted on a center pillar by a worker, and minimizing an amount of movement of the seat belt refractor towards the interior of a vehicle body in the event of a broadside collision.

### CROSS-REFERENCE TO RELATED APPLICATIONS

The present application claims priority of Korean Patent Application Number 10-2011-0133130 filed Dec. 12, 2011, the entire contents of which application is incorporated herein for all purposes by this reference.

### BACKGROUND OF INVENTION

1. Field of Invention

The present invention relates, in general, to an apparatus for mounting a seat belt retractor for a vehicle, and more particularly to an apparatus for mounting a seat belt retractor for a vehicle, capable of promoting the ease with which a worker does the mounting when the seat belt retractor is mounted, and minimizing injury to an occupant caused by the seat belt retractor in the event of a broadside collision.

2. Description of Related Art

As shown in FIG. 1, a seat 1 installed in a vehicle is equipped with a seat belt 2 that is able to restrain an upper body of an occupant in the event of a collision. The seat belt 2 is wound into a retractor 3.

The retractor 3 unwinds the seat belt 2 when the occupant buckles up the seat belt 2, and winds the unwound seat belt 2 when the occupant unbuckles the seat belt 2.

As shown in FIG. 2, the retractor 3 is coupled to the lower end of a center pillar 4 of a vehicle body. A retractor mounting hole 4a is formed in the lower end of the center pillar 4, and the retractor 3 is inserted into the retractor mounting hole 4a. A lower end bracket 5 integrated into the retractor 3 is fastened to a support bracket 6 coupled to the center pillar 4 using a lower end bolt 7. An upper end bracket 8 integrated into the retractor 3 is fastened to the center pillar 4 using an upper end bolt 9.

Here, when the retractor 3 is mounted in such a manner that the lower end bolt 7 is bolted first, and then the upper end bolt 9 is bolted, the retractor 3 before the upper end bolt 9 is rotated about the lower end bolt 7 in a clockwise or counterclockwise direction due to the center of gravity. For this reason, it is difficult to bolt the upper end bolt 9, so that the mounting work becomes difficult, and the productivity is reduced.

In contrast, when the upper end bolt 9 is bolted first, and then the lower end bolt 7 is bolted, the retractor 3 is also rotated about the upper end bolt 9 due to the center of gravity. In this case, the mounting work becomes inconvenient, and the productivity is reduced.

Further, this mounting structure of the retractor 3 is designed to be coupled to the center pillar 4 using only the lower and upper end bolts 7 and 9, and thus the coupling force is weak. In this case, the amount of movement of the retractor 3 towards the interior of the vehicle body is increased in the event of broadside collision, and the occupants' injuries become serious by the retractor 3.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for an apparatus for mounting a seat belt retractor for a vehicle, which improves the ease of mounting when a retractor is mounted on a center pillar, thereby allowing the man hours to be reduced and productivity promoted, and which reinforces the coupling force between the retractor and the center pillar, thereby making it possible to minimize the amount of movement which the retractor makes towards the interior of a vehicle body in the event of broadside collision and thereby the injuries of an occupant caused by the retractor.

Various aspects of the present invention provide for an apparatus for mounting a seat belt retractor for a vehicle, which includes a pocket bracket integrally coupled to a center pillar so as to be able to partially cover a lower end of a retractor mounting hole formed in the center pillar, a retractor lower end bracket integrally installed to the retractor inserted into the retractor mounting hole, hooked on the pocket bracket, and mounted on the pocket bracket via a lower end coupling member, and a retractor upper end bracket integrally installed to the retractor and mounted on the center pillar via an upper end coupling member.

Here, the retractor lower end bracket may include a plurality of hooks integrally protruding therefrom so as to be hooked on an upper end of the pocket bracket.

Further, the upper end of the pocket bracket may include a plurality of recesses that provide bearing surfaces so that the hooks are fitted into the recesses.

Also, the pocket bracket may include a coupling part that is surface-joined with an exterior side of the center pillar along a lower end edge of the retractor mounting hole by welding, and a pocket part that is bent from the coupling part so as to protrude toward an interior side of the center pillar through the retractor mounting hole, is mounted on the retractor lower end bracket via the lower end coupling member, and causes the hooks to be hooked on an upper end thereof.

Further, the retractor lower end bracket may be configured so that a base part thereof located below the hooks is mounted in the pocket part.

In addition, the pocket part may include a bead integrally formed to reinforce rigidity.

In the apparatus for mounting a seat belt retractor for a vehicle according to the embodiment of the present invention, it is possible to greatly improve the ease with which a worker mounts the retractor on the center pillar, so that it is possible to reduce the man hours and improve the productivity. Further, it is possible to greatly increase the rigidity of the coupling between the retractor and the center pillar, so that the amount of movement which the retractor makes towards the interior of a vehicle body can be minimized, thereby making it possible to minimize the injuries of an occupant caused by the retractor.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 shows an exemplary vehicle seat having a seat belt.

FIG. 2 is a view that explains a structure for installing a conventional retractor.

FIGS. 3 and 4 are views that explain an exemplary apparatus for mounting a seat belt retractor for a vehicle according to the invention.

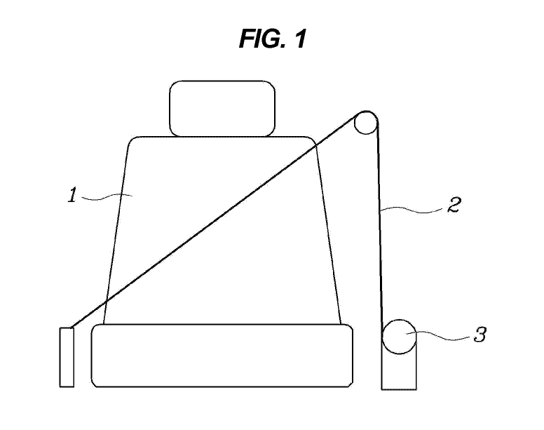

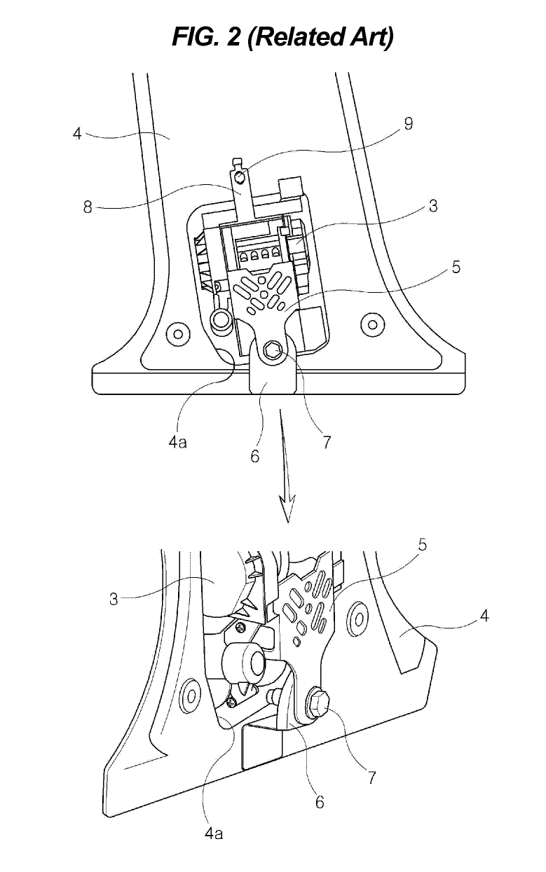

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

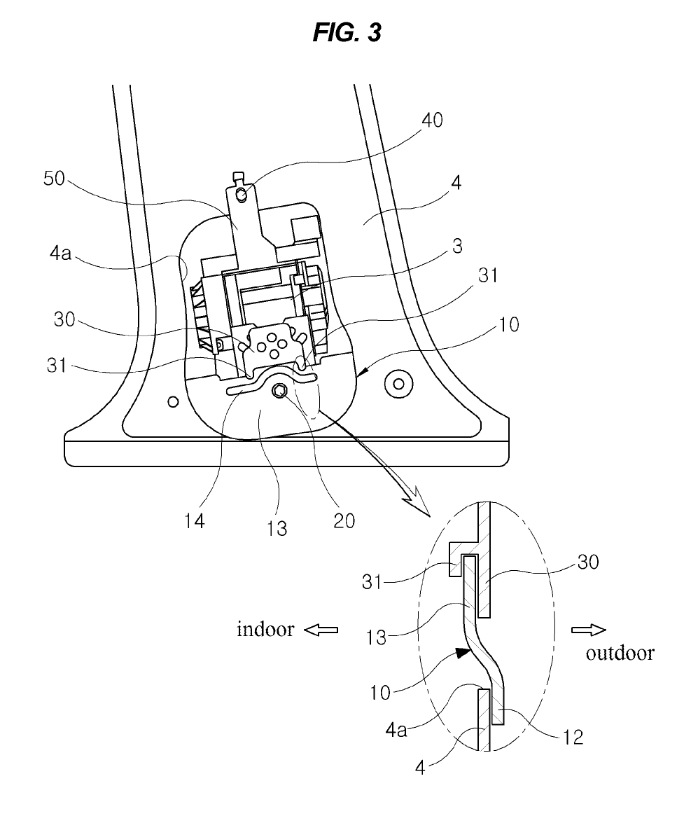

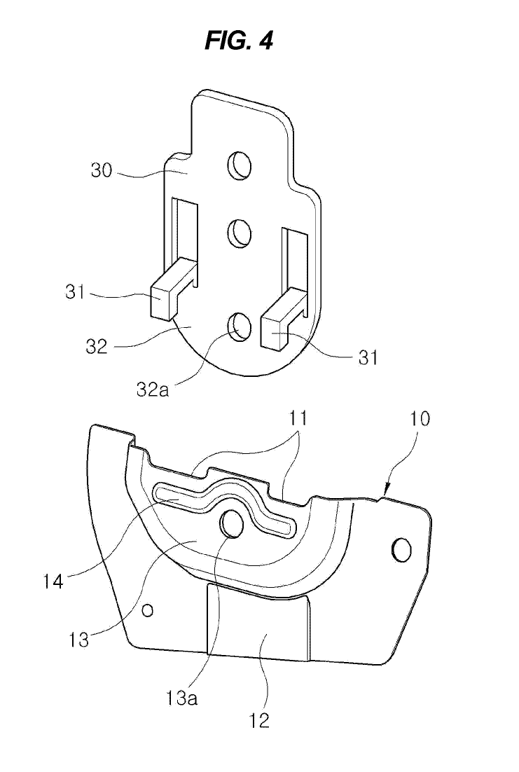

As shown in FIGS. 3 and 4, an apparatus for mounting a seat belt retractor for a vehicle according to various embodiments of the invention includes a pocket bracket 10 integrally coupled to a center pillar 4 so as to be able to cover a part of a lower end of a retractor mounting hole 4a formed in a lower portion of the center pillar 4, a retractor lower end bracket 30 integrally installed to the retractor 3 inserted into the retractor mounting hole 4a, hooked on the pocket bracket 10, and mounted on the pocket bracket 10 via a lower end coupling member 20, and a retractor upper end bracket 50 integrally installed to the retractor 3 and mounted on the center pillar 4 via an upper end coupling member 40. One will appreciate that in various embodiments, the integrally coupled pocket bracket may be monolithically formed with the center pillar, and/or the lower end bracket may be monolithically formed with structure of the retractor, and/or the retractor upper end bracket may be monolithically formed with structure of the retractor.

Here, and in various embodiments, the lower and upper end coupling members 20 and 40 may include, but are not limited to, bolts or screws.

The retractor lower end bracket 30 has a plurality of hooks 31 integrally protruding therefrom so as to be hooked on an upper end of the pocket bracket 10. One will appreciate in various embodiments the hooks may be monolithically formed with the retractor lower end bracket.

The shape of a cross-section of each hook 21 that protrudes from the retractor lower end bracket 30 is an L shape.

The upper end of the pocket bracket 10 is integrally provided with a plurality of recesses 11 that provide bearing surfaces so that the hooks 31 are fitted into the recesses 11.

Each recess 11 is recessed from the upper end of the pocket bracket 10 in a downward direction.

When the retractor 3 is mounted onto the center pillar 4, the recesses 11 and the hooks 31 serve to prevent movement of the retractor 3 so as to be able to restrict the mounting position of the retractor 3.

That is, the hooks 31 are fitted into the recesses 11 when the retractor 3 is positioned into the retractor mounting hole 4a so that the retractor 3 is supported on the pocket bracket 10, and is thereby prevented from being moved downwards by dead weight. The movement of the retractor 2 is particularly prevented after the hooks 31 have been fitted into the recesses 11. In this state, a worker can complete the mounting of the retractor 3 using the lower end coupling member 20 and the upper end coupling member 40.

When the structure whereby the retractor 3 is mounted is like this, the retractor 3 can be prevented from being moved downwards and being rotated by dead weight. Thus, mounting work of the retractor 3 becomes easier, and the man hours are reduced. Moreover, the productivity can be increased.

The pocket bracket 10 includes a coupling part 12 that is surface-joined with an exterior side of the center pillar 4 along a lower end edge of the retractor mounting hole 4a by welding, and a pocket part 13 bent from the coupling part 12 so as to protrude toward the interior side of the center pillar through the retractor mounting hole 4a, mounted on the retractor lower end bracket 30 via the lower end coupling member 20, and hooked at an upper end thereof by the hooks 31.

The structure of the retractor lower end bracket 30 is such that a base part 32 located below the hooks 31 is mounted in the pocket part 13.

As described above, the entire coupling part 12 of the pocket bracket 10 is welded with the exterior side of the center pillar 4 so as to make surface contact with the exterior side of the center pillar 4, the force with which the center pillar 4 and the pocket bracket 10 are coupled is able to be a one, to the end that the rigidity of the entire installation of the retractor 3 can be greatly improved.

When the rigidity of the overall installation of the retractor 3 is increased, it is possible to greatly improve the rigidity of which the retractor 3 against external impact, and thus it is possible to inhibit by as much as possible the amount of movement that the retractor 3 makes towards the interior of the vehicle body in the event of a broadside collision. As a result, it is possible to prevent to the fullest extent the injuries suffered by an occupant caused by the retractor 3.

Further, when the base part 32 of the retractor lower end bracket 30 is installed in the pocket part 13 so as to be superposed on the pocket part 13, the pocket part 13 can inhibit the movement of the retractor 3 toward the interior of the vehicle body in the event of a broadside collision. Thus, the amount of movement of the retractor 3 toward the interior of the vehicle body can be minimized, so that it is possible to prevent to the fullest extent the injuries of an occupant caused by the retractor 3.

To couple the pocket part 13 with the base part 32 of the retractor lower end bracket 30, both the pocket part 32 and the base part 13 are provided with coupling holes 32a and 13a through which the lower end coupling member 20 passes.

Meanwhile, the pocket part 13 is integrally provided with a bead 14 for reinforcing rigidity. One will appreciate that in various embodiments, the pocket part may be monolithically formed with the bead. The bead 14 prevents sharp deformation of the pocket part 13 caused by external impact, thereby contributing to minimizing the amount of movement of the retractor 3 towards the interior of the vehicle body in the event of a broadside collision.

As described above, the retractor mounting apparatus according to various embodiments of the present invention can greatly improve the ease with which a worker mounts the retractor 3 on the center pillar 4, so that it is possible to reduce the man hours and improve productivity.

Further, the retractor mounting apparatus can greatly increase the coupling rigidity of the retractor 3 and the center pillar 4, so that the amount of movement which the retractor 3 makes towards the interior of the vehicle body can be minimized, and thus it is possible to minimize the injuries of an occupant caused by the retractor 3.

For convenience in explanation and accurate definition in the appended claims, the terms upper or lower, front or rear, inside or outside, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A seat belt retractor apparatus for a vehicle, comprising:
a pocket bracket integrally coupled to a center pillar partially covering a lower end of a retractor mounting hole formed in the center pillar;
a retractor lower end bracket integrally installed to the retractor inserted into the retractor mounting hole, hooked on the pocket bracket, and mounted on the pocket bracket via a lower end coupling member; and
a retractor upper end bracket integrally installed on the retractor and mounted onto the center pillar via an upper end coupling member.

2. The apparatus according to claim 1, wherein the retractor lower end bracket includes a plurality of hooks integrally protruding therefrom hooked on an upper end of the pocket bracket.

3. The apparatus according to claim 2, wherein the upper end of the pocket bracket includes a plurality of recesses that provide bearing surfaces so that the hooks are fitted into the recesses.

4. The apparatus according to claim 2, wherein the pocket bracket includes a coupling part that is surface-joined with an exterior side of the center pillar along a lower end edge of the retractor mounting hole by welding, and a pocket part that is bent from the coupling part so as to protrude toward an interior side of the center pillar through the retractor mounting hole, is mounted on the retractor lower end bracket via the lower end coupling member, and causes the hooks to be hooked on an upper end thereof.

5. The apparatus according to claim 4, wherein the retractor lower end bracket includes a base part thereof located below the hooks is mounted in the pocket part.

6. The apparatus according to claim 4, wherein the pocket part includes a bead integrally formed to reinforce rigidity.
